(19) United States
(12) Patent Application Publication
(10) Pub. No.: US 2025/0372656 A1
(43) Pub. Date: Dec. 4, 2025

(54) ANODELESS ASSEMBLED, IN-SITU GENERATED LITHIUM METAL CELL

(71) Applicant: GM GLOBAL TECHNOLOGY OPERATIONS LLC, DETROIT, MI (US)

(72) Inventors: Nathaniel Hardin, Farmington Hills, MI (US); Yifan Zhao, Troy, MI (US); Jung Hwi Cho, Madison Heights, MI (US); Fang Dai, Troy, MI (US)

(21) Appl. No.: 18/731,442

(22) Filed: Jun. 3, 2024

(51) Int. Cl. H01M 4/62; B60L 50/64; H01M 4/131; H01M 4/505; H01M 4/525; H01M 50/211

(52) U.S. Cl. CPC H01M 4/628; B60L 50/64; H01M 4/131; H01M 4/505; H01M 4/525; H01M 50/211; H01M 2220/20

(57) ABSTRACT

Aspects of the disclosure include an anodeless assembled, in-situ generated lithium metal cell and methods of manufacturing the same. An exemplary vehicle includes an electric motor and a battery pack electrically coupled to the electric motor. The battery pack includes a battery cell that includes an anode current collector, an anode active material layer in direct contact with a surface of the anode current collector, a cathode current collector, and a cathode active material layer in direct contact with a surface of the cathode current collector. The cathode active material layer includes a cathode active material and a lithiation reagent. The anode active material layer includes a lithium metal layer deposited in-situ on the surface of the anode current collector via lithiation of a portion of the lithiation reagent in the cathode active material layer.

### INTRODUCTION

The present disclosure relates to battery cell manufacturing, and particularly to an anodeless assembled, in-situ generated lithium metal cell using voltage control and excess lithium deposition.

Lithium metal cells, also known as lithium metal batteries, are a type of rechargeable battery technology that have gained significant attention due to their high theoretical energy densities, meaning these types of batteries can potentially store more energy per unit mass or volume than conventional lithium-ion batteries. The anode (negative electrode) in a lithium metal cell is typically composed of metallic lithium, which has a relatively high specific capacity (e.g., 3,860 mAh/g) and a relatively low electrochemical potential (e.g., −3.04 V as measured against a hydrogen electrode). The cathode (positive electrode) can be made of various materials, such as lithium transition metal oxides (e.g., LiCoO₂, LiNiMnCoO₂, etc.), lithium metal phosphates (e.g., LiFePO₄), or other suitable compounds that can reversibly intercalate and deintercalate lithium ions.

The electrodes in a lithium metal cell are separated by an electrolyte, which is typically a lithium salt dissolved in an organic solvent or a solid polymer electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium metal atoms at the anode oxidize and release electrons, which flow through the external circuit to the cathode, providing electrical energy to power a device. At the same time, lithium ions migrate from the anode through the electrolyte and intercalate into the cathode material. During charging, this process is reversed, with lithium ions being extracted from the cathode and deposited back onto the anode as metallic lithium.

### SUMMARY

In one exemplary embodiment a vehicle includes an electric motor and a battery pack electrically coupled to the electric motor. The battery pack includes a battery cell that includes an anode current collector, an anode active material layer in direct contact with a surface of the anode current collector, a cathode current collector, and a cathode active material layer in direct contact with a surface of the cathode current collector. The cathode active material layer includes a cathode active material and a lithiation reagent. The anode active material layer includes a lithium metal layer deposited in-situ on the surface of the anode current collector via lithiation of a portion of the lithiation reagent in the cathode active material layer.

In addition to one or more of the features described herein, in some embodiments, the cathode active material includes at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR), lithium iron phosphate (LFP), and lithium manganese iron phosphate (LMFP).

In some embodiments, the lithiation reagent includes an irreversible anti-fluorite type lithiation reagent. In some embodiments, the irreversible anti-fluorite type lithiation reagent includes at least one of Li₆TeO₆ (hexagonal LTO), LisSbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

In some embodiments, the lithiation reagent includes an irreversible conversion type lithiation reagent. In some embodiments, the irreversible conversion type lithiation reagent includes at least one of Li₂O (lithium oxide), Li₃N (lithium nitride), Li₃P (lithium phosphide), lithium oxylate, Li₂S (lithium sulfide), lithium peroxide, lithium carbonate, and lithium hydroxide.

In some embodiments, the cathode active material includes NMC and the lithiation reagent includes LFO.

In another exemplary embodiment a battery cell includes an anode current collector, an anode active material layer in direct contact with a surface of the anode current collector, a cathode current collector, and a cathode active material layer in direct contact with a surface of the cathode current collector. The cathode active material layer includes a cathode active material and a lithiation reagent. The anode active material layer includes a lithium metal layer deposited in-situ on the surface of the anode current collector via lithiation of a portion of the lithiation reagent in the cathode active material layer.

In some embodiments, the cathode active material includes at least one of NCMA, NMC, NCA, LMO, LNMO, LMR, LFP, and LMFP.

In some embodiments, the lithiation reagent includes an irreversible anti-fluorite type lithiation reagent. In some embodiments, the irreversible anti-fluorite type lithiation reagent includes at least one of hexagonal LTO, lithium-antimony oxide, LFO, lithium-platinum oxide, lithium-iridium oxide, lithium-zinc oxide, lithium-cobalt oxide, lithium-manganese oxide, lithium-molybdenum oxide, lithium-tungsten oxide, and spinel lithium-manganese oxide.

In some embodiments, the lithiation reagent includes an irreversible conversion type lithiation reagent. In some embodiments, the irreversible conversion type lithiation reagent includes at least one of lithium oxide, lithium nitride, lithium phosphide, lithium oxylate, lithium sulfide, lithium peroxide, lithium carbonate, and lithium hydroxide.

In some embodiments, the cathode active material includes NMC and the lithiation reagent includes LFO.

In yet another exemplary embodiment a method can include forming a battery cell by forming an anode current collector, forming an anode active material layer in direct contact with a surface of the anode current collector, forming a cathode current collector, and forming a cathode active material layer in direct contact with a surface of the cathode current collector. The cathode active material layer includes a cathode active material and a lithiation reagent. The anode active material layer includes a lithium metal layer deposited in-situ on the surface of the anode current collector via lithiation of a portion of the lithiation reagent in the cathode active material layer.

In some embodiments, the cathode active material includes at least one of NCMA, NMC, NCA, LMO, LNMO, LMR, LFP, and LMFP.

In some embodiments, the lithiation reagent includes an irreversible anti-fluorite type lithiation reagent. In some embodiments, the irreversible anti-fluorite type lithiation reagent includes at least one of hexagonal LTO, lithium-antimony oxide, LFO, lithium-platinum oxide, lithium-iridium oxide, lithium-zinc oxide, lithium-cobalt oxide, lithium-manganese oxide, lithium-molybdenum oxide, lithium-tungsten oxide, and spinel lithium-manganese oxide.

In some embodiments, the lithiation reagent includes an irreversible conversion type lithiation reagent. In some embodiments, the irreversible conversion type lithiation reagent includes at least one of lithium oxide, lithium nitride, lithium phosphide, lithium oxylate, lithium sulfide, lithium peroxide, lithium carbonate, and lithium hydroxide.

In some embodiments, the cathode active material includes NMC and the lithiation reagent includes LFO.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 3A is a first step for fabricating anodeless assembled, in-situ generated lithium metal cells in accordance with one or more embodiments;

FIG. 3B is a second step for fabricating anodeless assembled, in-situ generated lithium metal cells in accordance with one or more embodiments;

FIG. 3C is a third step for fabricating anodeless assembled, in-situ generated lithium metal cells in accordance with one or more embodiments;

FIG. 4 is a voltage-gravimetric capacity graph for various lithiation reagents in accordance with one or more embodiments;

FIG. 5 is change-discharge curves in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of a final integrated device (e.g., a battery). A current collector typically includes a sheet of conductive material (e.g., aluminum foil) to which an active electrode material is attached. An energy storage system such as a battery cell or pouch can include a number of stacked anode current collectors and cathode current collectors, an active material(s) dispersed or otherwise situated on the current collectors, and a sufficient number of separators to prevent shorts between the anode current collectors and cathode current collectors. Thus, in many electrode configurations there is a clear separation between anode and cathode, and each electrode serves a specific function, with electrons flowing from the anode to the cathode through an external circuit.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Lithium metal cells, for example, are an increasingly relied upon rechargeable battery technology. Lithium metal cells have the potential to offer significantly higher energy densities as compared to conventional lithium-ion batteries, making them attractive for applications that require high energy storage capacity, such as electric vehicles and grid-scale energy storage systems. In particular, lithium metal has a very high theoretical specific capacity of 3,860 mAh/g, which translates to a relatively higher energy density than found in conventional lithium-ion batteries. Moreover, lithium metal has a low electrochemical potential (−3.04 V as compared to standard hydrogen electrode), which results in a higher cell voltage when paired with suitable cathode materials. The potentially higher specific capacities and higher voltages can lead to batteries having improved energy efficiency and reduced heat generation.

Challenges remain, however, in designing and manufacturing lithium metal batteries. On the manufacturing side, for example, challenges include sourcing, fabricating, and handling the lithium metal anodes. Lithium metal is a highly reactive material, making its production and handling more complex and costly compared to the other types of anode materials used in conventional lithium-ion batteries. The processes for extracting and purifying lithium metal require specialized facilities and strict safety protocols, which can increase manufacturing costs. Moreover, building thin and uniform lithium metal anodes is difficult, as lithium metal is soft and malleable, making it prone to dendrite formation and uneven deposition during the anode fabrication process. This can lead to reduced cycle life and inconsistent performance across cells. Lithium metal is also highly reactive with air and moisture, necessitating strict environmental controls during anode fabrication and cell assembly. Lithium metal anode manufacturing often relies upon specialized equipment for air and moisture control, such as dry rooms or gloveboxes, which can significantly increase manufacturing costs and complexity. Turning now to cell assembly, careful handling is required to ensure anode integrity and to prevent short circuits via inadvertent lithium metal contact. The result is a more labor-intensive manufacturing process which requires specific quality control processes, potentially impacting production yields and costs, and ultimately, scalability.

This disclosure introduces an anodeless assembled, in-situ generated lithium metal cell and methods of manufacturing the same. As used herein, an “anodeless” assembled battery cell refers to a cell that is manufactured without an anode—or more specifically, without anode active material layer. The anode current collector, if present, is bare. That is, rather than relying on conventional anode fabrication processes, an anodeless assembled battery cell refers to a battery cell manufactured with a bare anode current collector (e.g., a copper plate or foil) and, after initial fabrication, voltage control and/or excess lithium deposition are leveraged to form an anode active material layer in-situ. In particular, a battery cell is formed anodeless using a bare anode current collector and mixed cathode materials selected such that voltage controls and/or an irreversible lithiation reagent can be leveraged during the first formation cycle to deposit a permanent lithium metal film on the anode current collector. This deposited lithium metal film serves as the anode in the battery cell, largely eliminating the need for, and the complexities associated with, anode fabrication and manufacture. Other advantages are also realized, such as, for example, increased handling safety. In short, an anodeless assembled, in-situ generated lithium metal cell can be tailored via voltage and/or irreversible lithiation reagent control to have only the minimum amount of lithium required to achieve cycle life and performance targets.

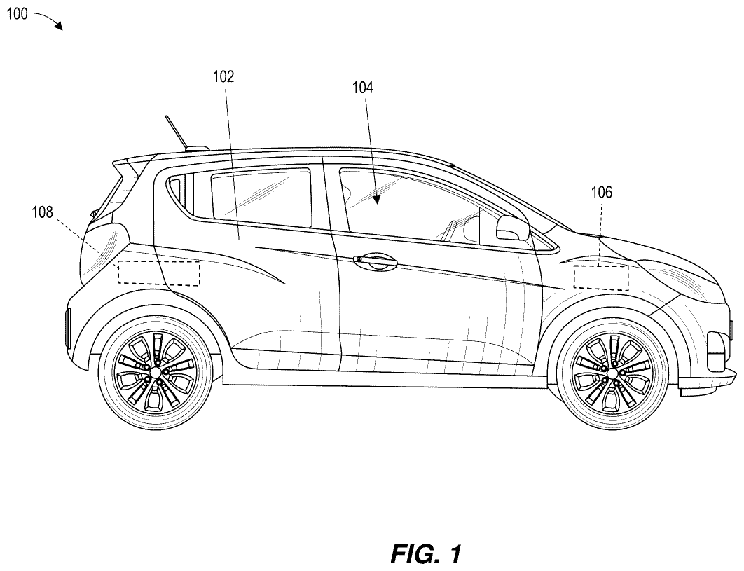

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

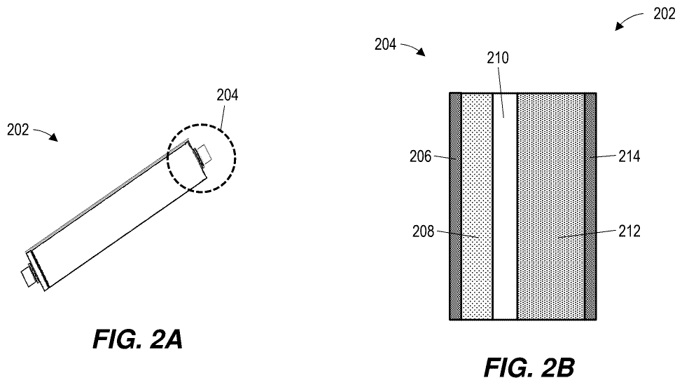

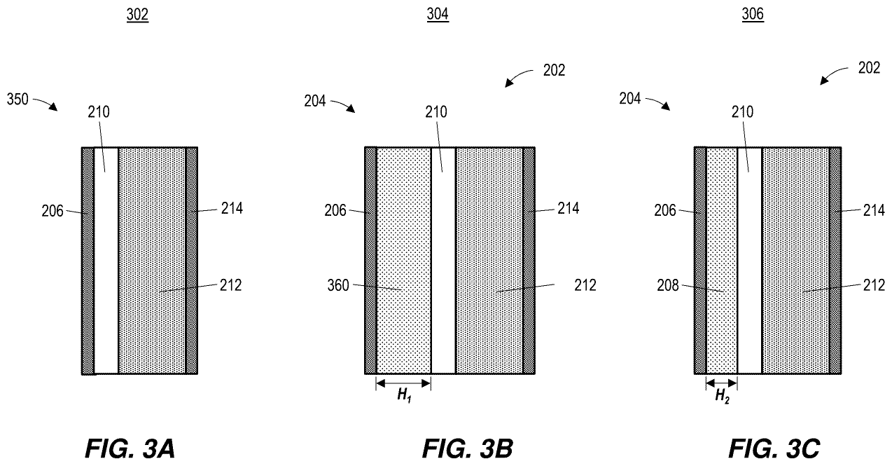

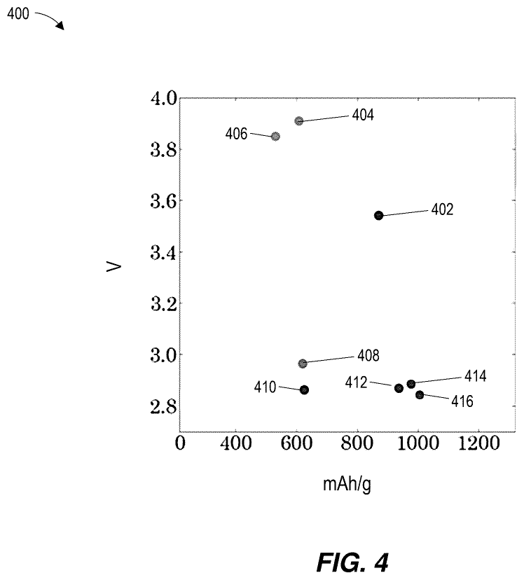

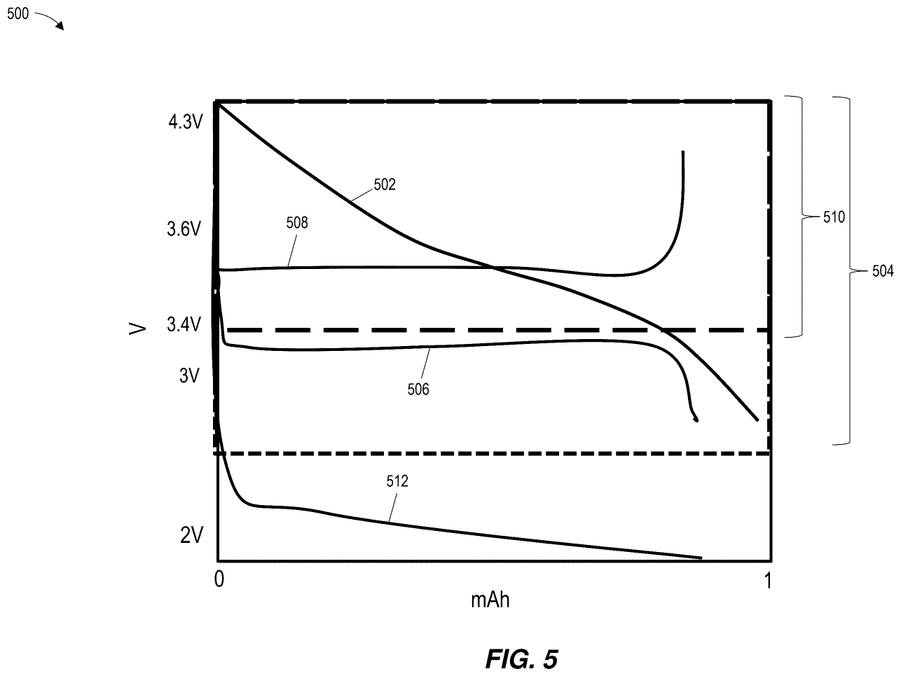

As will be detailed herein, the battery pack 108 includes one or more battery modules and/or battery pouches having anodeless assembled, in-situ generated lithium metal cells. An example battery cell is shown in FIG. 2A. A detailed view of the battery cell of FIG. 2A is shown in FIG. 2B. A manufacturing process for anodeless assembled, in-situ generated lithium metal cells is shown in FIGS. 3A, 3B, and 3C. Example curves for maximum voltage (V) and total gravimetric capacity (mAh/g) for a range of lithiation reagents is shown in FIG. 4. Example change-discharge curves for a range of battery chemistries is shown in FIG. 5.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. As shown in FIG. 2B, the battery cell 202 includes, from left to right, an anode current collector 206, an anode active material layer 208, a separator 210, a cathode active material layer 212, and a cathode current collector 214, configured and arranged as shown.

The anode current collector 206 and the cathode current collector 214 can be made of sheets or foils of conductive materials. For example, the cathode current collector 214 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 214 is made of aluminum foil. The anode current collector 206 can include, for example, copper foil and/or one or more graphene layers. In some embodiments, the anode current collector 206 is made of copper foil. Each layer thickness can be approximately 1 to 3 nm, although other thicknesses are within the contemplated scope of this disclosure.

The anode active material layer 208 is formed in-situ. Thus, in some embodiments, the anode current collector 206 is initially formed in direct contact with the separator 210. In some embodiments, the anode active material layer 208 is a lithium metal layer (also referred to as a lithium metal anode). The formation of the anode active material layer 208 is discussed in greater detail with respect to FIGS. 3A, 3B, and 3C.

In some embodiments, the cathode active material layer 212 includes a cathode active material(s) and a lithiation reagent(s). The cathode active material layer 212 is not meant to be particularly limited, but can include, for example, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), and lithium nickel manganese oxide (LNMO).

In some embodiments, the cathode active material layer 212 includes, in addition to the cathode active material(s), a lithiation reagent(s). A lithiation reagent refers to a compound(s) that undergo an irreversible lithiation process when cycling. In some embodiments, the lithiation reagent is an irreversible anti-fluorite type lithiation reagent. In some embodiments, the lithiation reagent is an irreversible conversion type lithiation reagent. The presence of the lithiation reagent(s) and/or their byproducts (see discussion below) within the cathode active material layer 212 serves as a physical signature of an anodeless assembled, in-situ generated lithium metal cell as described herein.

An irreversible anti-fluorite type lithiation reagent refers to a compound that can undergo an irreversible lithiation process to form a lithium-rich, anti-fluorite structure. The anti-fluorite structure is a structural type characterized by a face-centered cubic (FCC) arrangement of anions such as oxygen or fluorine, with cations (e.g., lithium and transition metals) occupying at least some of the tetrahedral and octahedral interstitial sites. An anti-fluorite structure is closely related to fluorite structures but with a different cation arrangement. Specifically, in the case of an anti-fluorite structure, the anion sublattice still maintains the FCC arrangement, similar to the fluorite structure, but instead of occupying all the tetrahedral interstitial sites, the cations in an anti-fluorite structure occupy both tetrahedral and octahedral interstitial sites within the anion framework. These reagents are “irreversible” reagents as the structural changes and rearrangements that occur during the lithiation process are not reversible during the delithiation process in a battery. The irreversible anti-fluorite type lithiation reagent is not meant to be particularly limited, but can include, for example, transition metal oxides and fluorides such as Li₆TeO₆ (hexagonal LTO), Li₅SbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

An irreversible conversion type lithiation reagent refers to a compound that can undergo an irreversible lithiation process that results in the complete reduction of a transition metal compound (e.g., an oxide, nitride, phosphide, etc.) by lithium ions during the lithiation process, thereby forming lithium-metal or lithium-metal alloy nanoparticles embedded within a lithium-containing matrix. These reagents are “irreversible” reagents as the structural changes and rearrangements that occur during the conversion reaction are not reversible during the delithiation process in a battery. In other words, the original crystalline structure and composition of the transition metal compound cannot be fully recovered after the conversion reaction has taken place. For example, when lithium reacts with iron oxide (Fe₂O₃), a conversion reaction takes place, forming lithium oxide (Li₂O) and metallic iron nanoparticles. During the discharge process in a battery, this reaction is only reversible to some extent, as the lithium can be extracted from the Li₂O matrix, but the original Fe₂O₃ structure cannot be fully restored, as the iron remains in the form of nanoparticles embedded within the Li₂O matrix. The irreversible conversion type lithiation reagent is not meant to be particularly limited, but can include, for example, Li₂O (lithium oxide), Li₃N (lithium nitride), Li₃P (lithium phosphide), lithium oxylate, Li₂S (lithium sulfide), lithium peroxide, lithium carbonate, and lithium hydroxide.

Depending on battery construction (e.g., conventional vs. bi-polar current collectors, etc.) the separator 210 is optional but, if included, can be positioned to isolate the anode active material layer 208 (after formed in-situ) and the cathode active material layer 212. The separator 210 can include dielectric materials such as, for example, polyethylene (PE), polypropylene (PP), polyethylene terephthalate (PET), and composites thereof, although other dielectrics are within the contemplated scope of this disclosure. In some embodiments, the separator 210 may include a thermally stable coating layer to improve shrinkage behavior (e.g., a porous ceramic coating or porous ester type polymer coating including, for example, polyimide, polyamide, polyimide-polyamide (PI/PA) copolymer, etc.).

A three-step manufacturing process for fabricating anodeless assembled, in-situ generated lithium metal cells is shown in FIGS. 3A, 3B, and 3C. FIG. 3A illustrates a first step 302 for fabricating anodeless assembled, in-situ generated lithium metal cells in accordance with one or more embodiments. FIG. 3B illustrates a second step 304 for fabricating anodeless assembled, in-situ generated lithium metal cells in accordance with one or more embodiments. FIG. 3C illustrates a third step 306 for fabricating anodeless assembled, in-situ generated lithium metal cells in accordance with one or more embodiments.

As shown in FIG. 3A, step 302 begins with fabricating and/or sourcing an anodeless battery cell 350. In some embodiments, the anodeless battery cell 350 includes, from left to right, an anode current collector 206, a separator 210, a cathode active material layer 212, and a cathode current collector 214, configured and arranged in a similar manner as descried previously with respect to the battery cell 202 (refer to FIG. 2B). Notably, however, the anodeless battery cell 350 does not include an anode active material layer 208. Instead, the anode current collector 206 is formed directly against the separator 210.

In some embodiments, the cathode active material layer 212 includes a cathode active material(s) and a lithiation reagent(s), such as an irreversible anti-fluorite type lithiation reagent and/or an irreversible conversion type lithiation reagent, as discussed with respect to FIG. 2B. At this stage (pre-lithiation), the presence of the lithiation reagent(s) within the cathode active material layer 212 of the anodeless battery cell 350 serves as a physical signature that the anodeless battery cell 350 has been fabricated according to one or more embodiments.

In some embodiments, the loading of the lithiation reagent(s) within the cathode active material layer 212 is selected to target a predetermined lithium metal thickness in the in-situ formed anode active material layer 208 post-lithiation (refer to FIG. 3C). In some embodiments, the lithiation reagent loading is varied according to the specific capacity of the selected lithiation reagent and a known lithium deposition rate of the selected lithiation reagent. To illustrate, consider a cathode active material layer 212 that includes LFO as the lithiation reagent. LFO has a specific capacity of about 700 mAh/g. Without wishing to be bound by theory, during lithiation, LFO deposits lithium metal on the anode current collector 206 primarily via a lithium extraction process that is predominantly a release of oxygen, with the net loss being an off-gassed lithia (Li₂O) and a residual lithium-iron-oxide product (referred to herein as a lithiation reagent byproduct) having an Fe₂O₃-rich composition. The lithium metal deposition rate is 5 microns/cm² for every 1 mAh/cm² of LFO capacity. Continuing with the prior example, to target a deposition of 17.5 microns of lithium metal on the anode active material layer 208 post-lithiation would require a loading of 5 mg/cm² of LFO (5 mg/cm² of Li₅FeO₄*700 mAh/g is 3.5 mAh/cm² of Li₅FeO₄ capacity, and 3.5 mAh/cm² of Li₅FeO₄ capacity*5 microns/cm² is 17.5 microns of lithium metal). Of course, these loadings and lithium deposition targets are merely illustrative, and other loadings can be determined for other lithium targets using any desired lithiation reagent in a similar manner, and all such configurations are within the contemplated scope of this disclosure.

As shown in FIG. 3B, step 304 begins after the anodeless battery cell 350 is fabricated and/or sourced according to step 302 (refer to FIG. 3A). In some embodiments, the anodeless battery cell 350 is subjected during step 304 to a formation cycle that generates, in-situ, a lithium metal layer 360 on the anode current collector 206. In some embodiments, the formation cycle includes a first charge cycle and a first discharge cycle. In some embodiments, the first charge cycle results in lithiating a surface of the anode current collector 206, thereby forming the lithium metal layer 360, via a conversion of a portion of the lithiation reagent(s) in the cathode active material layer 212 as described previously. In some embodiments, the lithium metal layer 360 is deposited in this manner to a first thickness H₁. The first thickness H₁ varies according to the specific capacity of the selected lithiation reagent and the lithium deposition rate of the selected lithiation reagent. Once the lithium metal layer 360 is formed, the anodeless battery cell 350 can be referred to as a battery cell (e.g., the battery cell 202 of FIG. 2B).

As shown in FIG. 3C, step 306 begins after the first formation cycle in step 304 (refer to FIG. 3B). In some embodiments, the battery cell 202 is cycled during step 306 to remove any temporary lithiation compounds from the anode current collector 206, thereby leaving a permanent lithium metal film (e.g., the anode active material layer 208 of FIG. 2B) on the anode current collector 206. Thus, in some embodiments, the remaining, permanent anode active material layer 208 has a second thickness H₂ that is less than the first thickness H₁. The second thickness H₂ is not meant to be particularly limited. The anode active material layer 208 can be formed to any desired thickness by varying the loading and selection of the lithiation reagent(s) as discussed previously. At this stage (post-lithiation, post-cycling), the presence of the lithiation reagent(s) and/or their byproducts, such as, LFO and/or it's lithiation byproduct Fe₂O₃, within the cathode active material layer 212 of the battery cell 202 serves as a physical signature that the battery cell 202 has been fabricated according to one or more embodiments.

Regardless of the lithiation reagent loading of a given application, the balance of the cathode active material layer 212 is the cathode active material(s). In some embodiments, the battery cell 202 includes an active formulation of 90 percent by weight cathode active material (e.g., NMC) and 10 percent by weight lithiation reagent (e.g., Li₅FeO₄), although other relative weights, such as 50:50, 60:40, 70:30, 80:20, 95:5, etc., are within the contemplated scope of this disclosure. In some embodiments, the cathode active material layer 212 includes 95 percent by weight active material and lithiation reagents (again, split as desired, such as 70:30), 3 percent by weight binder, and 2 percent by weight conductive carbon, although other relative weights are within the contemplated scope of this disclosure. For example, in some embodiments, cathode active material layer 212 is an NMC layer having an active material loading by weight of between 90 and 98 percent (of which 90 percent by weight is NMC and 10 percent by weight is Li₅FeO₄), with 2 to 8 percent binder (e.g., PVDF, etc.), and a carbon additive of between 0.1 and 5 percent. Binders are not meant to be particularly limited but can include, for example, PVDF, CMC, PVDF-Co-HFP, LiPAA, PAA, PVA, and PVP.

FIG. 4 illustrates a voltage-gravimetric capacity graph 400 for various lithiation reagents in accordance with one or more embodiments. More specifically, the voltage-gravimetric capacity graph 400 illustrates the total gravimetric capacity (mAh/g) of a range of lithiation reagents at maximum voltage (V) during a first charge/discharge cycle (refer to Kirklin S, Chan M K Y, Trahey L, et al. High-throughput screening of high-capacity electrodes for hybrid Li-ion-Li—O 2 cells [J]. Physical Chemistry Chemical Physics, 2014, 16(40): 22073-22082). While not exhaustive, the lithiation reagents include, for example, Li₅FeO₄ (402), Li₆TeO₆ (404), Li₅SbO₅ (406), Li₈PtO₆ (408), Li₈IrO₆ (410), Li₆ZnO₄ (412), Li₆CoO₄ (414), and Li₆MnO₄ (416). As shown in FIG. 4, lithiation reagents have a relatively high (greater than 600 mAh/g) capacity on first charge. Moreover, Li₅FeO₄ (402), Li₆ZnO₄ (412), Li₆CoO₄ (414), and Li₆MnO₄ (416) have a capacity that is greater than 700 mAh/g on first charge.

FIG. 5 illustrates change-discharge curves 500 in accordance with one or more embodiments. For example, a first change-discharge curve 502 depicts the cycling behavior of an NMC battery cell over a normal voltage range 504 between 2.5 V (or 3 V) and 4.3 V. In some embodiments, manufacturing anodeless assembled, in-situ generated lithium metal cells does not rely on (or does not rely solely on) irreversible anti-fluorite type or irreversible conversion type lithiation reagents. Instead, or in addition, voltage controls can be leveraged to ensure permanent lithium metal deposition when cycling.

To illustrate, compare a second change-discharge curve 506 for an LFP battery cell over the normal voltage range 504 between 2.5 V (or 3 V) and 4.3 V against a third change-discharge curve 508 for an LFP battery cell which is regulated using voltage control to a restricted voltage range 510 between 3.4 V and 4.3 V. Observe that, advantageously, when held in the restricted voltage range 510, an LFP battery cell will charge, but will not discharge. That is, lithium metal generated during the charge cycle will remain on the respective anode, thus leaving behind an anode active material layer 208 on the anode current collector 206. To illustrate further, consider a fourth change-discharge curve 512 for Li₅FeO₄, which, by inspection, falls far outside the normal voltage range 504 between 2.5 V (or 3 V) and 4.3 V.

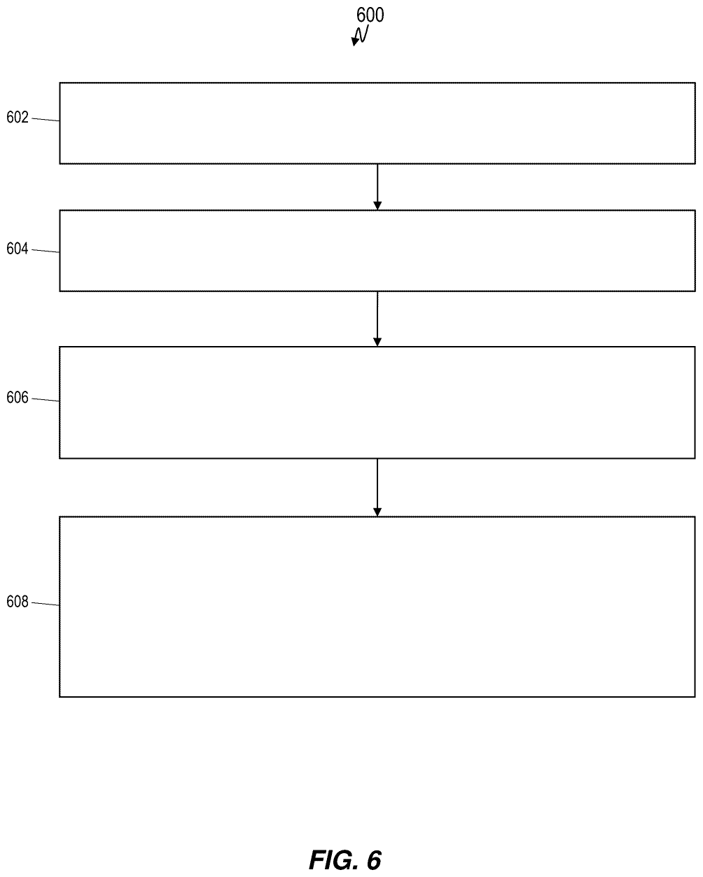

Referring now to FIG. 6, a flowchart 600 for manufacturing anodeless assembled, in-situ generated lithium metal cells is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming an anode current collector.

At block 604, the method includes forming an anode active material layer in direct contact with a surface of the anode current collector.

At block 606, the method includes forming a cathode current collector.

At block 608, the method includes forming a cathode active material layer in direct contact with a surface of the cathode current collector. In some embodiments, the cathode active material layer includes a cathode active material and a lithiation reagent.

In some embodiments, the anode active material layer includes a lithium metal layer deposited in-situ on the surface of the anode current collector via lithiation of a portion of the lithiation reagent in the cathode active material layer.

In some embodiments, the cathode active material includes at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR), lithium iron phosphate (LFP), and lithium manganese iron phosphate (LMFP).

In some embodiments, the lithiation reagent includes an irreversible anti-fluorite type lithiation reagent. In some embodiments, the irreversible anti-fluorite type lithiation reagent includes at least one of Li₆TeO₆ (hexagonal LTO), Li₅SbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

In some embodiments, the lithiation reagent includes an irreversible conversion type lithiation reagent. In some embodiments, the irreversible conversion type lithiation reagent includes at least one of Li₂O (lithium oxide), Li₃N (lithium nitride), Li₃P (lithium phosphide), lithium oxylate, Li₂S (lithium sulfide), lithium peroxide, lithium carbonate, and lithium hydroxide.

In some embodiments, the cathode active material includes NMC and the lithiation reagent includes LFO.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
an anode current collector;
an anode active material layer in direct contact with a surface of the anode current collector;
a cathode current collector; and
a cathode active material layer in direct contact with a surface of the cathode current collector, the cathode active material layer comprising a cathode active material and a lithiation reagent;
wherein the anode active material layer comprises a lithium metal layer deposited in-situ on the surface of the anode current collector via lithiation of a portion of the lithiation reagent in the cathode active material layer.

2. The vehicle of claim 1, wherein the cathode active material comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR), lithium iron phosphate (LFP), and lithium manganese iron phosphate (LMFP).

3. The vehicle of claim 2, wherein the lithiation reagent comprises an irreversible anti-fluorite type lithiation reagent.

4. The vehicle of claim 3, wherein the irreversible anti-fluorite type lithiation reagent comprises at least one of Li₆TeO₆ (hexagonal LTO), Li₅SbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

5. The vehicle of claim 2, wherein the lithiation reagent comprises an irreversible conversion type lithiation reagent.

6. The vehicle of claim 5, wherein the irreversible conversion type lithiation reagent comprises at least one of Li₂O (lithium oxide), Li₃N (lithium nitride), Li₃P (lithium phosphide), lithium oxylate, Li₂S (lithium sulfide), lithium peroxide, lithium carbonate, and lithium hydroxide.

7. The vehicle of claim 1, wherein the cathode active material comprises nickel manganese cobalt oxide (NMC) and the lithiation reagent comprises Li₅FeO₄ (LFO).

8. A battery cell comprising:
an anode current collector;
an anode active material layer in direct contact with a surface of the anode current collector;
a cathode current collector; and
a cathode active material layer in direct contact with a surface of the cathode current collector, the cathode active material layer comprising a cathode active material and a lithiation reagent;
wherein the anode active material layer comprises a lithium metal layer deposited in-situ on the surface of the anode current collector via lithiation of a portion of the lithiation reagent in the cathode active material layer.

9. The battery cell of claim 8, wherein the cathode active material comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR), lithium iron phosphate (LFP), and lithium manganese iron phosphate (LMFP).

10. The battery cell of claim 9, wherein the lithiation reagent comprises an irreversible anti-fluorite type lithiation reagent.

11. The battery cell of claim 10, wherein the irreversible anti-fluorite type lithiation reagent comprises at least one of Li₆TeO₆ (hexagonal LTO), Li₅SbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

12. The battery cell of claim 9, wherein the lithiation reagent comprises an irreversible conversion type lithiation reagent.

13. The battery cell of claim 12, wherein the irreversible conversion type lithiation reagent comprises at least one of Li₂O (lithium oxide), Li₃N (lithium nitride), Li₃P (lithium phosphide), lithium oxylate, Li₂S (lithium sulfide), lithium peroxide, lithium carbonate, and lithium hydroxide.

14. The battery cell of claim 8, wherein the cathode active material comprises nickel manganese cobalt oxide (NMC) and the lithiation reagent comprises Li₅FeO₄ (LFO).

15. A method comprising:
forming an anode current collector;
forming an anode active material layer in direct contact with a surface of the anode current collector;
forming a cathode current collector; and
forming a cathode active material layer in direct contact with a surface of the cathode current collector, the cathode active material layer comprising a cathode active material and a lithiation reagent;
wherein the anode active material layer comprises a lithium metal layer deposited in-situ on the surface of the anode current collector via lithiation of a portion of the lithiation reagent in the cathode active material layer.

16. The method of claim 15, wherein the cathode active material comprises at least one of nickel cobalt manganese aluminum oxide (NCMA), nickel manganese cobalt oxide (NMC), nickel cobalt aluminum oxide (NCA), lithium manganese oxide (LMO), lithium nickel manganese oxide (LNMO), lithium manganese rich (LMR), lithium iron phosphate (LFP), and lithium manganese iron phosphate (LMFP).

17. The method of claim 16, wherein the lithiation reagent comprises an irreversible anti-fluorite type lithiation reagent.

18. The method of claim 17, wherein the irreversible anti-fluorite type lithiation reagent comprises at least one of Li₆TeO₆ (hexagonal LTO), Li₅SbO₅ (lithium-antimony oxide), Li₅FeO₄ (LFO), Li₈PtO₆ (lithium-platinum oxide), Li₈IrO₆ (lithium-iridium oxide), Li₆ZnO₄ (lithium-zinc oxide), Li₆CoO₄ (lithium-cobalt oxide), Li₆MnO₄ (lithium-manganese oxide), Li₄MoO₅ (lithium-molybdenum oxide), Li₄WO₅ (lithium-tungsten oxide), and Li₄Mn₅O₁₂ (spinel lithium-manganese oxide).

19. The method of claim 16, wherein the lithiation reagent comprises an irreversible conversion type lithiation reagent.

20. The method of claim 19, wherein the irreversible conversion type lithiation reagent comprises at least one of Li₂O (lithium oxide), Li₃N (lithium nitride), Li₃P (lithium phosphide), lithium oxylate, Li₂S (lithium sulfide), lithium peroxide, lithium carbonate, and lithium hydroxide.
